(19) United States
(12) Patent Application Publication
(10) Pub. No.: US 2026/0089357 A1
(43) Pub. Date: Mar. 26, 2026

(54) METHOD FOR PERFORMING ADAPTIVE FRAME RATE ADJUSTMENT IN ELECTRONIC DEVICE FOR ENHANCING SCENE EXPERIENCE, AND ASSOCIATED APPARATUS

(71) Applicant: MEDIATEK INC., Hsinchu City (TW)

(72) Inventors: Yao-Sheng Chen, Hsinchu City (TW); Shih-Ting Huang, Hsinchu City (TW); Chiu-Jen Lin, Hsinchu City (TW); Yin Chen, Hsinchu City (TW)

(73) Assignee: MEDIATEK INC., Hsinchu City (TW)

(21) Appl. No.: 19/315,643

(22) Filed: Aug. 31, 2025

Related U.S. Application Data
(60) Provisional application No. 63/698,074, filed on Sep. 24, 2024.

(51) Int. Cl. H04N 21/2343; H04N 21/2187; H04N 21/2662

(52) U.S. Cl. CPC H04N 21/2343; H04N 21/2187; H04N 21/2662

(57) ABSTRACT

A method for performing adaptive frame rate adjustment in an electronic device for enhancing scene experience and associated apparatus are provided. The method applicable to the electronic device includes: utilizing a processing circuit within the electronic device to determine whether at least one predetermined activation criterion regarding the adaptive frame rate adjustment is satisfied to generate at least one determination result; in response to the determination result indicating that the predetermined activation criterion is satisfied, utilizing the processing circuit to change a frame rate of an input frame source within the electronic device, for obtaining multiple input frames from the input frame source within a predetermined time limit; and utilizing the processing circuit to perform image processing of a visual effect according to the multiple input frames to generate at least one output frame having the visual effect, for being displayed by a display under control of the processing circuit.

### CROSS REFERENCE TO RELATED APPLICATIONS

This application claims the benefit of U.S. Provisional Application No. 63/698,074, filed on Sep. 24, 2024. The content of the application is incorporated herein by reference.

### BACKGROUND

The present invention is related to display control, and more particularly, to a method for performing adaptive frame rate adjustment in an electronic device for enhancing scene experience, and associated apparatus such as a chipset, an electronic device implemented as a mobile device, etc.

According to the related art, in mobile applications, live streaming is currently a very popular use case. In these applications, facial effects are often added to the live stream. However, the disappearance of these effects during the live stream is a serious issue for users and can negatively impact their viewing experience. Thus, a novel method and associated architecture are needed for solving the problem of the related art without introducing any side effect or in a way that is less likely to introduce a side effect.

### SUMMARY

It is an objective of the present invention to provide a method for performing adaptive frame rate adjustment in an electronic device for enhancing scene experience, and associated apparatus such as a chipset, an electronic device implemented as a mobile device, etc., in order to solve the above-mentioned problem.

At least one embodiment of the present invention provides a method for performing adaptive frame rate adjustment in an electronic device (e.g., a mobile device) for enhancing scene experience, where the method is applicable to the electronic device. For example, the method may comprise: utilizing a processing circuit within the electronic device to determine whether at least one predetermined activation criterion regarding the adaptive frame rate adjustment is satisfied to generate at least one determination result, for selectively changing a frame rate of an input frame source (e.g., a camera) within the electronic device according to the at least one determination result, wherein the at least one determination result indicates whether the at least one predetermined activation criterion is satisfied; in response to the at least one determination result indicating that the at least one predetermined activation criterion is satisfied, utilizing the processing circuit to change the frame rate of the input frame source, for obtaining multiple input frames from the input frame source within a predetermined time limit; and utilizing the processing circuit to perform image processing of a visual effect according to the multiple input frames to generate at least one output frame having the visual effect, for being displayed by a display under control of the processing circuit.

At least one embodiment of the present invention provides a chipset that is operating according to the method mentioned above, wherein the chipset is implemented by way of at least one integrated circuit (IC), and the processing circuit is positioned within the at least one IC. For example, the at least one IC may comprise a single IC corresponding to a system-on-chip (SoC) design. In another example, the at least one IC may comprise multiple ICs within which the processing circuit and a communication control circuit are positioned, respectively, wherein the communication control circuit is arranged to perform communication control for the electronic device.

At least one embodiment of the present invention provides an electronic device (e.g., a mobile device), for performing adaptive frame rate adjustment in the electronic device for enhancing scene experience. The electronic device may comprise a processing circuit that is arranged to control operations of the electronic device. The electronic device may further comprise a display that is coupled to the processing circuit and arranged to display information for the electronic device. For example, the electronic device may be arranged to utilize the processing circuit to determine whether at least one predetermined activation criterion regarding the adaptive frame rate adjustment is satisfied to generate at least one determination result, for selectively changing a frame rate of an input frame source (e.g., a camera) within the electronic device according to the at least one determination result, wherein the at least one determination result indicates whether the at least one predetermined activation criterion is satisfied. In response to the at least one determination result indicating that the at least one predetermined activation criterion is satisfied, the electronic device may be arranged to utilize the processing circuit to change the frame rate of the input frame source, for obtaining multiple input frames from the input frame source within a predetermined time limit. In addition, the electronic device may be arranged to utilize the processing circuit to perform image processing of a visual effect according to the multiple input frames to generate at least one output frame having the visual effect, for being displayed by the display under control of the processing circuit.

It is an advantage of the present invention that, through proper design, the proposed method of the present invention, as well as the associated apparatus such as the chipset, the electronic device implemented as the mobile device, etc., can monitor the usage scenarios, and adaptively change or adjust the frame rate of the input frame source (e.g., the camera) for one or more predetermined usage scenarios, in order to accelerate the speed of applying the visual effects such as the facial effects, and therefore enhance the overall performance. In addition, the present invention method and apparatus can solve the related art problem without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 is a diagram illustrating a multi-layer control scheme according to an embodiment of the present invention.

FIG. 3 is a diagram illustrating an effect disappearance prevention control scheme of a method for performing adaptive frame rate adjustment in an electronic device for enhancing scene experience according to an embodiment of the present invention.

FIG. 4 is a diagram illustrating a dynamic frame per second (FPS) control scheme of the method according to an embodiment of the present invention.

FIG. 5 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to. . . ”. Also, the term “couple” is intended to mean either an indirect or direct electrical connection. Accordingly, if one device is coupled to another device, that connection may be through a direct electrical connection, or through an indirect electrical connection via other devices and connections.

The proposed method of the present invention, as well as the associated apparatus such as the chipset, the electronic device implemented as the mobile device, etc., can accelerate the speed of applying the visual effects such as the facial effects to enhance the user experience of the user. Currently, some effects may require multiple frames to be fully rendered on a face, which is not an ideal experience for users. For example, in live streaming scenarios, users who apply the facial effects (e.g., beauty effects) to their faces may encounter one or more issues among the following issues:
(1) the effects suddenly disappear; and
(2) the processing speed of the effects is not fast enough;
   where both of these issues will result in a poor user experience. The proposed method of the present invention, as well as the associated apparatus such as the chipset, the electronic device implemented as the mobile device, etc., can significantly reduce the occurrence of the problems. For example, when it is determined that a new effect needs to be generated, the frame rate can be increased to speed up the associated processing, allowing the fully rendered effect to be displayed on the screen more quickly.

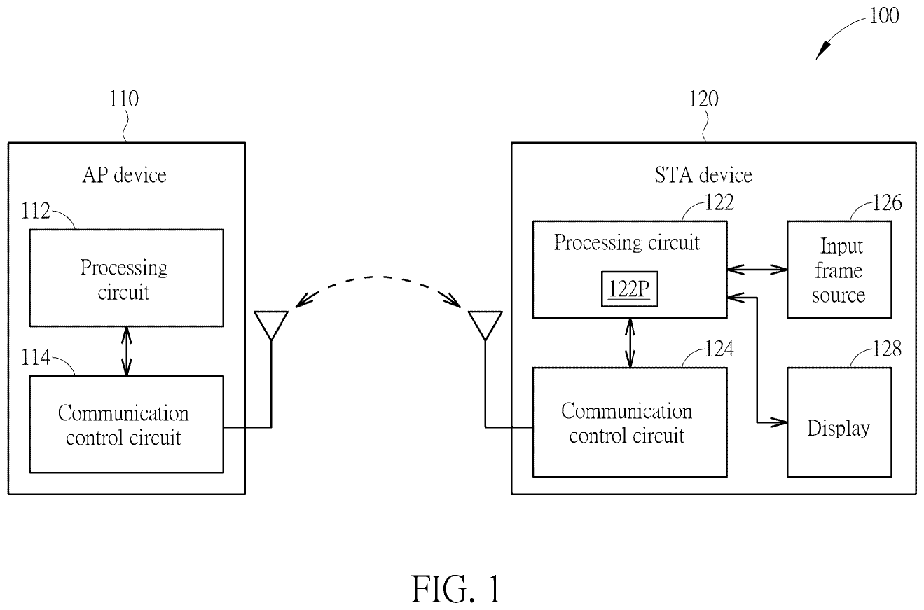

FIG. 1 is a diagram of a wireless communication system 100 according to an embodiment of the present invention. For better comprehension, the wireless communication system 100 (e.g., any device therein) may be compatible or backward compatible with one or more versions of the Institute of Electrical and Electronics Engineers (IEEE) 802.11 standards, but the present invention is not limited thereto. As shown in FIG. 1, the wireless communication system 100 may comprise multiple electronic devices such as the access point (AP) device 110 and the station (STA) device 120. The AP device 110 may comprise a processing circuit 112, at least one communication control circuit (e.g., one or more communication control circuits), which may be collectively referred to as the communication control circuit 114, and at least one antenna (e.g., one or more antennas) coupled to the communication control circuit 114. The STA device 120 may comprise a processing circuit 122, at least one communication control circuit (e.g., one or more communication control circuits), which may be collectively referred to as the communication control circuit 124, and at least one antenna (e.g., one or more antennas) coupled to the communication control circuit 124, as well as an input frame source 126 and a display 128. In the architecture shown in FIG. 1, the processing circuit 112 can be arranged to control operations of the AP device 110, and the communication control circuit 114 can be arranged to perform communication control, and more particularly, perform wireless communication operations with the STA device 120 (or the communication control circuit 124 thereof) for the AP device 110. In addition, the processing circuit 122 can be arranged to control operations of the STA device 120, and the communication control circuit 124 can be arranged to perform communication control, and more particularly, perform wireless communication operations with the AP device 110 (or the communication control circuit 114 thereof) for the STA device 120. The processing circuit 122 may execute at least one program module (e.g., one or more program modules), which may be collectively referred to as the program module 122P, and the program module 122P running on the processing circuit 122 may be arranged to control the operations of the STA device 120. For example, the program module 122P may comprise an operating system (OS), one or more drivers, application programs, etc.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP device 110 may include, but are not limited to: a Wi-Fi router. In addition, the processing circuit 122 can be implemented by way of at least one processor/microprocessor, at least one RAM, at least one bus, etc., the communication control circuit 124 can be implemented by way of at least one wireless network control circuit, the input frame source 126 can be implemented by way of at least one camera, and the display 128 can be implemented by way of a display panel such as a touch-sensitive display panel, but the present invention is not limited thereto. Examples of the STA device 120 may include, but are not limited to: a multifunctional mobile phone, a laptop computer, an all-in-one computer and a wearable device.

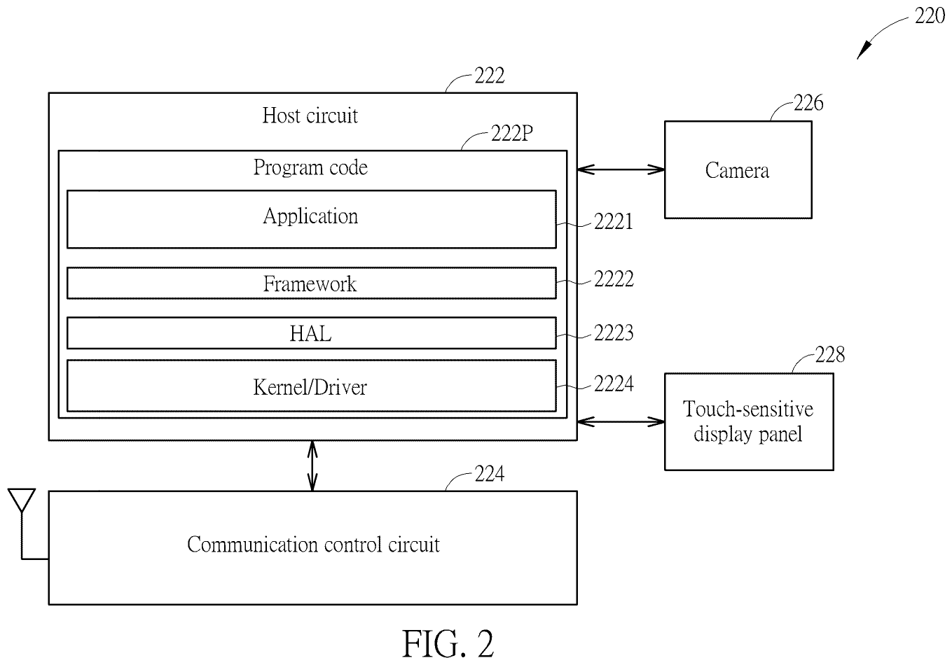

FIG. 2 is a diagram illustrating a multi-layer control scheme according to an embodiment of the present invention, where a STA device 220 operating based on the multi-layer control scheme can be taken as an example of the STA device 120 shown in FIG. 1. The STA device 220 comprises a host circuit 222, a communication control circuit 224, a camera 226 and a touch-sensitive display panel 228, which can be taken as examples of the processing circuit 122, the communication control circuit 124, the input frame source 126 and the display 128, respectively. For better comprehension, the host circuit 201 can be configured to execute a set of program codes 222P as a set of program modules running on the host circuit 222, respectively, and these program modules can be configured as multiple layers of program modules, such as the applications 2221 (referred to as “the Apps 2221” hereinafter), the framework 2222, the hardware abstraction layer (HAL) 2223 and the kernel/drivers 2224 (e.g., the Linux kernel, as well as various types of drivers therein such as a camera driver, one or more display drivers, one or more audio drivers, and other drivers), but the present invention is not limited thereto. According to some embodiments, the architecture shown in FIG. 2 may vary. For example, the STA device 220 can be implemented as any electronic device among the multifunctional mobile phone, the laptop computer, the all-in-one computer, the wearable device, etc.

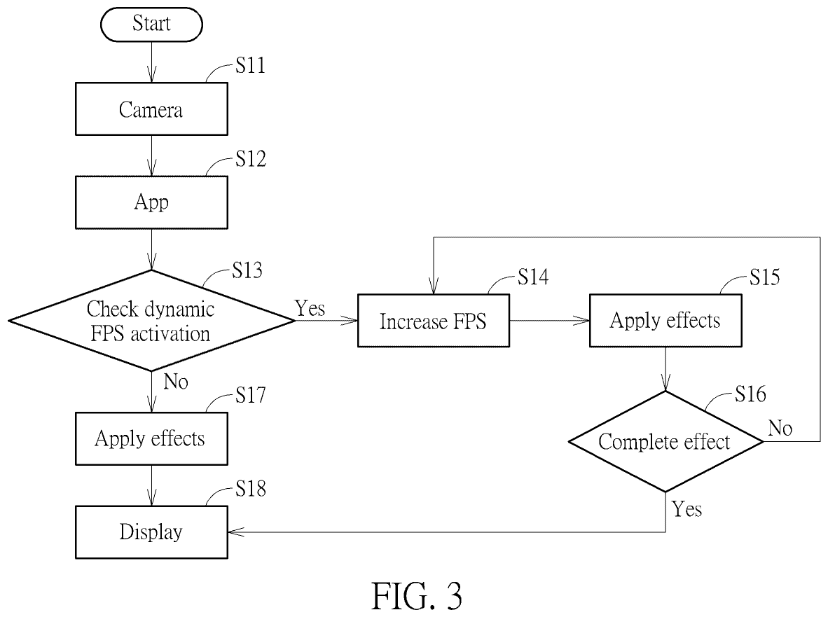

FIG. 3 is a diagram illustrating an effect disappearance prevention control scheme of a method for performing adaptive frame rate adjustment in an electronic device (e.g., the STA device 120 shown in FIG. 1, such as the STA device 220 shown in FIG. 2) for enhancing scene experience according to an embodiment of the present invention. The electronic device such as the STA device 120 can utilize the processing circuit 122 therein to determine whether at least one predetermined activation criterion regarding the adaptive frame rate adjustment is satisfied to generate at least one determination result, for selectively changing a frame rate (e.g., a frame rate expressed with FPS) of the input frame source 126 within the electronic device according to the at least one determination result, where the at least one determination result indicates whether the at least one predetermined activation criterion is satisfied. In response to the at least one determination result indicating that the at least one predetermined activation criterion is satisfied, the electronic device such as the STA device 120 can utilize the processing circuit 122 to change the frame rate of the input frame source 126, for obtaining multiple input frames {f(i)} from the input frame source 126 within a predetermined time limit, and to perform image processing of a visual effect according to the multiple input frames {f(i)} to generate at least one output frame {F(j)} having the visual effect, for being displayed by the display 128 under control of the processing circuit 122.

Taking the architecture shown in FIG. 2 as an example, the electronic device can utilize a camera application (e.g., camera-based App) among the Apps 2221 to control the camera 226 with the aid of the camera driver running on the host circuit 222, and to apply the visual effect (e.g., at least one facial effect), and the associated operations can be described with Steps S11 to S18 as follows:

(S11) the electronic device can control the camera 226 to start generating a series of input frames {f(i)|i=0, 1, 2, 3, 4, . . . } for the camera application such as the camera-based App, in particular, for live streaming (labeled “Camera”for brevity);
(S12) the electronic device can utilize the camera application such as the camera-based App to start performing the image processing of the visual effect (e.g., the at least one facial effect) according to the series of input frames {f(i)|i=0, 1, 2, 3, 4, . . . } from the camera 226, for generating a series of output frames {F(j)|j=0, 1, 2, . . . } to be displayed as an output of the camera-based App by the touch-sensitive display panel 228 (labeled “App”for brevity);
(S13) the electronic device can utilize the host circuit 222 to determine (or check) whether the aforementioned at least one predetermined activation criterion such as at least one dynamic FPS activation criterion (in particular, the dynamic FPS activation criterion for determining whether to change the FPS for enhancing the scene experience) is satisfied (labeled “Check dynamic FPS activation” for brevity), in order to generate a corresponding determination result of Step S13, such as one of the positive and negative determination results of Step S13, wherein: if the corresponding determination result is equal to the positive determination result (labeled “Yes” for brevity), Step S14 is entered; otherwise, in a situation where the corresponding determination result is equal to the negative determination result (labeled “No” for brevity), Step S17 is entered;
(S14) the electronic device can utilize the host circuit 222 to change the frame rate (e.g., the frame rate expressed with the FPS) of the camera 226 with the aid of the camera driver running on the host circuit 222, and more particularly, to increase the frame rate such as the FPS (labeled “Increase FPS” for brevity), where the multiple input frames {f(i)} can be obtained from the camera 226 within the predetermined time limit;
(S15) the electronic device can utilize the host circuit 222 to perform the image processing of the visual effect (e.g., the at least one facial effect) according to one or more input frames (e.g., the multiple input frames {f(i)} that are obtained from the camera 226 within the predetermined time limit) among the series of input frames {f(i)|i=0, 1, 2, 3, 4, . . . } to generate at least one frame (e.g., the aforementioned at least one output frame F(j) having the visual effect) among the series of output frames {F(j)|j=0, 1, 2, . . . }, for being displayed as a part of the output of the camera-based App by the touch-sensitive display panel 228 (labeled “Apply effects”for brevity);
(S16) the electronic device can utilize the host circuit 222 to determine (or check) whether the aforementioned at least one frame has been processed to have the complete effect such as the visual effect that is completed applied (labeled “Complete effect” for brevity), in order to generate a corresponding determination result of Step S16, such as one of the positive and negative determination results of Step S16, wherein: if the corresponding determination result is equal to the positive determination result (labeled “Yes” for brevity), Step S18 is entered; otherwise, in a situation where the corresponding determination result is equal to the negative determination result (labeled “No”for brevity), Step S14 is entered;
(S17) the electronic device can utilize the host circuit 222 to perform the image processing of the visual effect (e.g., the at least one facial effect) according to one or more input frames {f(i)} among the series of input frames {f(i)|i=0, 1, 2, 3, 4, . . . } to generate one or more output frames {F(j)} among the series of output frames {F(j)|j=0, 1, 2, . . . }, for being displayed as a part of the output of the camera-based App by the touch-sensitive display panel 228 (labeled “Apply effects” for brevity); and
(S18) the electronic device can utilize the touch-sensitive display panel 228 to display the output frames {F(j)} having the visual effect (e.g., the at least one facial effect).

For better comprehension, the effect disappearance prevention control scheme may be illustrated with the working flow shown in FIG. 3, but the present invention is not limited thereto. According to some embodiments, one or more steps may be added, deleted, or changed in the working flow shown in FIG. 3.

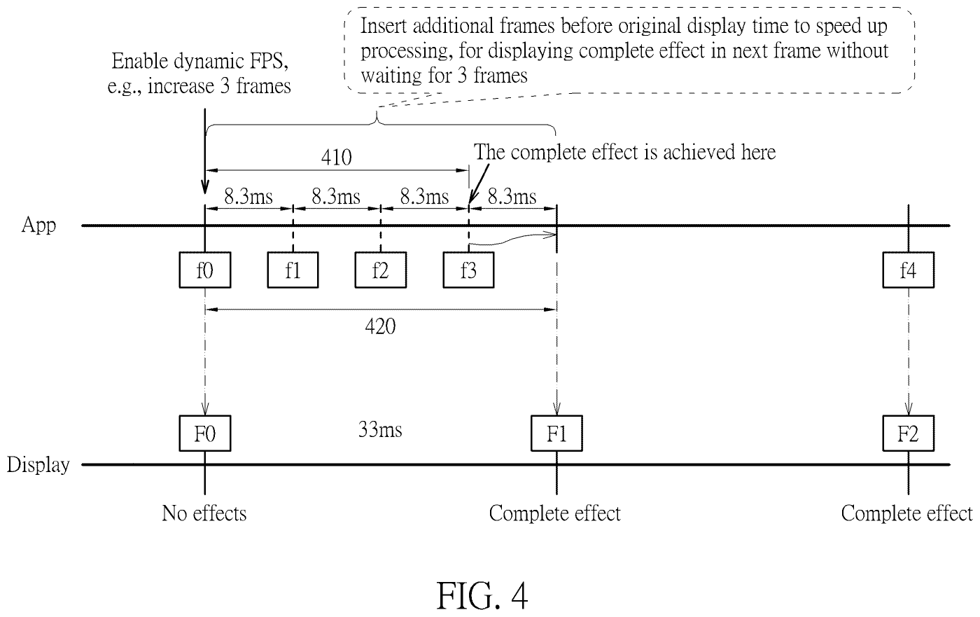

FIG. 4 is a diagram illustrating a dynamic frame per second (FPS) control scheme of the method according to an embodiment of the present invention. The timing for generating the series of input frames {f(i)|i=0, 1, 2, 3, 4, . . . } for the camera application such as the camera-based App and the timing for generating the series of output frames {F(j)|j=0, 1, 2, . . . } for the display 128 such as the touch-sensitive display panel 228 can be illustrated with the upper half part and the lower half part of the timing chart shown in FIG. 4, respectively. For better comprehension, the input frames f0, f1, f2, f3, f4, etc. can be taken as examples of the series of input frames {f(i)|i=0, 1, 2, 3, 4, . . . }, the input frames f0, f1, f2 and f3 can be taken as examples of the multiple input frames {f(i)} that are obtained from the input frame source 126 such as the camera 226 within the predetermined time limit, the output frames F0, F1, F2, etc. can be taken as examples of the series of output frames {F(j)|j=0, 1, 2, . . . }, and the output frame F1 can be taken as an example of the aforementioned at least one output frame F(j), but the present invention is not limited thereto. According to some embodiments, the series of input frames {f(i)|i=0, 1, 2, 3, 4, . . . }, the multiple input frames {f(i)}, the series of output frames {F(j)|j=0, 1, 2, . . . }, and/or the aforementioned at least one output frame F(j) may vary.

The predetermined time limit 410 may represent the predetermined time limit mentioned above. The predetermined time limit 410 can be less than or equal to a time period 420 corresponding to an original frame rate (i.e., the original frame rate prior to starting changing the frame rate of the input frame source 126 such as the camera 226), and can be illustrated as a time limit less than the time period 420 in FIG. 4 for better comprehension, but the present invention is not limited thereto. According to some embodiments, the predetermined time limit 410 can be illustrated as a time limit equal to the time period 420. In addition, the time period 420 is equal to the reciprocal of the original frame rate. Assuming that the original frame rate is equal to 30 FPS, the time period 420 is equal to (1/30)=0.03333 . . . , measured in units of seconds(s), which means the time period 420 is equal to 33.33 . . . milliseconds (ms) (labeled “33 ms” for brevity). At an initial time point for generating the input frame f0, the electronic device can utilize the processing circuit 122 such as the host circuit 222 to enable the dynamic FPS to change the frame rate, for example, from the original frame rate such as 30 FPS to four times the original frame rate, such as 120 FPS, in order to increase the number of input frames {f(i)} within the predetermined time limit 410 with a predetermined increment such as three (labeled “increase 3 frames”for brevity).

As shown in FIG. 4, the multiple input frames {f(i)} may comprise an initial input frame such as the input frame f0 and at least one additional input frame inserted within the predetermined time limit 410, such as the input frames f1, f2 and f3. The initial input frame such as the input frame f0 is obtained from the input frame source 126 such as the camera 226 at the initial time point. For example, the initial time point can be equal to or earlier than the time point of starting changing the frame rate of the input frame source 126 (e.g., the camera 226), which means the initial input frame such as the input frame f0 is obtained at the initial time point, no later than the time point of starting changing the frame rate of the input frame source 126. In addition, changing the frame rate of the input frame source 126 (e.g., the camera 226) comprises increasing the frame rate of the input frame source 126, making the aforementioned at least one additional input frame such as the input frames f1, f2 and f3 be inserted within the predetermined time limit 410. As the three input frames f1, f2 and f3 can be generated subsequently at the higher frame rate of 120 FPS, the time period corresponding to the higher frame rate is equal to (1/120)=0.0083333..., measured in units of seconds(s), which means the time period corresponding to the higher frame rate is equal to 8.3333 . . . ms (labeled “8.3 ms” for brevity). As a result, the predetermined time limit 410 can be equal to three times the time period corresponding to the higher frame rate.

If an effect like the visual effect (e.g., the at least one facial effect) requires three frames to process, the electronic device can control the input frame source 126 such as the camera 226 to insert additional frames such as the input frames f1, f2 and f3 before the original display time (e.g., the time point at which the output frame F1 is generated) to speed up the processing. In this way, the complete effect can be displayed in the next frame such as the output frame F1, without waiting for three frames such as the three consecutive output frames F1, F2, etc. starting from the output frame F1. As shown in FIG. 4, changing the frame rate of the input frame source 126 (e.g., the camera 226) may comprise:
(1) temporarily increasing the frame rate of the input frame source 126 to obtain the aforementioned at least one additional input frame such as the input frames f1, f2 and f3 from the input frame source 126, for example, at the higher frame rate such as 120 FPS, for accelerating the speed of applying the visual effect; and
(2) after temporarily increasing the frame rate of the input frame source 126, decreasing the frame rate of the input frame source 126, to make the frame rate be equal to the original frame rate (i.e., the original frame rate prior to starting changing the frame rate of the input frame source 126) such as 30 FPS;
   where the subsequent input frames f4, etc. coming after the three input frames f1, f2 and f3 among the series of input frames {f(i)|i=0, 1, 2, 3, 4, . . . } can be generated at the original frame rate such as 30 FPS. For any output frame F(j) with j>0 (referred to as “the output frame F(j>0 )” hereinafter) among the series of output frames {F(j)|j=0, 1, 2, . . . }, at the time for performing the image processing of the visual effect to obtain the output frame F(j>0), there are at least three consecutive input frames {f(i)} available for the image processing of the visual effect. Therefore, it is proper to decrease the frame rate of the input frame source 126 after temporarily increasing the frame rate of the input frame source 126 as described above.

In the above embodiments, the effect like the visual effect (e.g., the at least one facial effect) requires three input frames {f(i)} to process, and the electronic device can control the input frame source 126 such as the camera 226 to insert the additional frames such as the three input frames f1, f2 and f3 before the original display time (e.g., the time point at which the output frame F1 is generated) to speed up the processing. This is for illustrative purposes only, and is not meant to be a limitation of the present invention. According to some embodiments, the number of the input frames {f(i)} that are required for performing the visual effect may vary, and the number of the additional frames (e.g., the three input frames f1, f2 and f3) may vary correspondingly.

Some implementation details regarding the dynamic FPS control scheme may be further described as follows. The aforementioned at least one predetermined activation criterion may be related to at least one of the following: whether the image processing of the visual effect needs to be started, and whether the previous image processing of the visual effect needs to be restarted. More particularly, the aforementioned at least one predetermined activation criterion may comprise one of or a combination of the following scenarios (a), (b) and (c):
(a) the camera application such as the camera-based App is opened for the first time during the usage period of the electronic device, where the input frame source 126 represents the camera 226;
(b) a change in the number of detected faces is observed, where the visual effect comprises the aforementioned at least one facial effect; and
(c) the facial detection algorithm of the image processing of the visual effect reaches at least one detection limit (e.g., one or more detection limit) of the facial detection algorithm, where the aforementioned at least one detection limit may include at least one of the following: the face angle reaches a predetermined face angle threshold (which may indicate that the face angle is too large), and the movement speed reaches a predetermined movement speed threshold (which may indicate that the movement speed is too fast);
   where changing the frame rate of the input frame source 126 (e.g., the camera 226) may comprise dynamically increasing the frame rate of the input frame source 126 based on at least one need of at least one usage scenario, rather than directly increasing the frame rate to an upper limit for all usage scenarios. In the adaptive frame rate adjustment configuration, the number of frames can be dynamically increased based on the needs of the usage scenario. For example, if the perceived change time difference is 42 ms, the original frame rate such as the original sensor frame rate of 30 FPS can be increased to 60 FPS. Therefore, considering the power consumption of the platform, it is not directly (or unlimitedly/infinitely) increased to 120 FPS.

Based on the dynamic FPS control scheme, with the aid of the aforementioned at least one additional input frame (e.g., the input frames f1, f2 and f3) inserted within the predetermined time limit 410 among the multiple input frames {f(i)}, the processing circuit 122 such as the host circuit 222 can be configured to enhance a complete effect rate of the series of output frames {F(j)|j=0, 1, 2, . . . }, such as the rate of the number of output frames {F(j)} having the visual effect to the number of the series of output frames {F(j)|j=0, 1, 2, . . . }, and can be configured to reduce an effect disappearance rate of the series of output frames {F(j)|j=0, 1, 2, . . . }, such as the rate of the number of output frames {F(j)} without the visual effect to the number of the series of output frames {F(j)|j=0, 1, 2, . . . }.

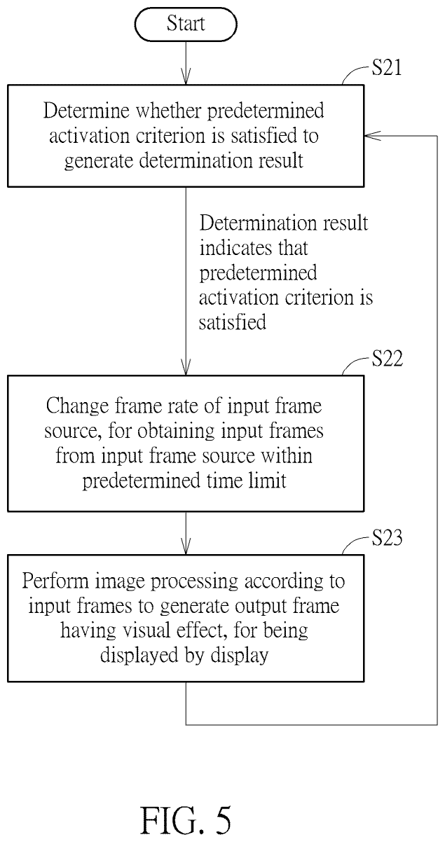

FIG. 5 illustrates a working flow of the method according to an embodiment of the present invention. The associated apparatus of the proposed method, such as the electronic device (e.g., the STA device 120 shown in FIG. 1, such as the STA device 220 shown in FIG. 2), a chipset within the electronic device, etc., can operate according to the working flow shown in FIG. 5. More particularly, the chipset can be implemented by way of at least one IC, for being installed at the electronic device, and the processing circuit 122 (e.g., the host circuit 222) can be positioned within the aforementioned at least one IC. For example, the aforementioned at least one IC may comprise a single IC corresponding to an SoC design. In another example, the aforementioned at least one IC may comprise multiple ICs within which the processing circuit 122 (e.g., the host circuit 222) and the communication control circuit 124 (e.g., the communication control circuit 224) are positioned, respectively, where the communication control circuit 122 is arranged to perform communication control for the electronic device.

In Step S21, the electronic device such as the STA device 120 can utilize the processing circuit 122 therein to determine whether at least one predetermined activation criterion regarding the adaptive frame rate adjustment is satisfied to generate at least one determination result, for selectively changing the frame rate of the input frame source 126 within the electronic device according to the aforementioned at least one determination result, where the aforementioned at least one determination result indicates whether the aforementioned at least one predetermined activation criterion is satisfied.

In Step S22, when the aforementioned at least one determination result indicates that the aforementioned at least one predetermined activation criterion is satisfied, the electronic device such as the STA device 120 can utilize the processing circuit 122 to change the frame rate of the input frame source 126, for obtaining multiple input frames {f(i)} from the input frame source 126 within a predetermined time limit such as the predetermined time limit 410.

In Step S23, the electronic device such as the STA device 120 can utilize the processing circuit 122 to perform the image processing of a visual effect such as that mentioned above according to the multiple input frames {f(i)} to generate at least one output frame F(j) having the visual effect, for being displayed by the display 128 under the control of the processing circuit 122.

The aforementioned at least one output frame F(j) can be used as a part of the series of output frames {F(j)|j=0, 1, 2, . . . } for being displayed by the display 128 such as the touch-sensitive display panel 228 under the control of the processing circuit 122 such as the host circuit 222, where the series of output frames {F(j)|j=0, 1, 2, . . . } can be output frames {F(j)} belonging to a live stream. For brevity, similar descriptions for this embodiment are not repeated in detail here.

For better comprehension, the method may be illustrated with the working flow shown in FIG. 5, but the present invention is not limited thereto. According to some embodiments, one or more steps may be added, deleted, or changed in the working flow shown in FIG. 5. For example, the electronic device such as the STA device 120 can utilize the processing circuit 122 to perform the image processing of the visual effect according to the multiple input frames {f(i)} to generate the aforementioned at least one output frame F(j) having the visual effect, for being displayed by an external display outside the electronic device (e.g., a projector linked to the STA device 120) under control of the processing circuit 122. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing adaptive frame rate adjustment in an electronic device for enhancing scene experience, the method being applicable to the electronic device, the method comprising:
utilizing a processing circuit within the electronic device to determine whether at least one predetermined activation criterion regarding the adaptive frame rate adjustment is satisfied to generate at least one determination result, for selectively changing a frame rate of an input frame source according to the at least one determination result, wherein the at least one determination result indicates whether the at least one predetermined activation criterion is satisfied;
in response to the at least one determination result indicating that the at least one predetermined activation criterion is satisfied, utilizing the processing circuit to change the frame rate of the input frame source, for obtaining multiple input frames from the input frame source within a predetermined time limit; and
utilizing the processing circuit to perform image processing of a visual effect according to the multiple input frames to generate at least one output frame having the visual effect, for being displayed by a display under control of the processing circuit.

2. The method of claim 1, wherein the predetermined time limit is less than or equal to a time period corresponding to an original frame rate, the original frame rate prior to starting changing the frame rate of the input frame source.

3. The method of claim 2, wherein the time period is equal to a reciprocal of the original frame rate.

4. The method of claim 1, wherein the multiple input frames comprise an initial input frame and at least one additional input frame inserted within the predetermined time limit.

5. The method of claim 4, wherein the initial input frame is obtained from the input frame source at an initial time point, no later than a time point of starting changing the frame rate of the input frame source; and changing the frame rate of the input frame source comprises increasing the frame rate of the input frame source, making the at least one additional input frame be inserted within the predetermined time limit.

6. The method of claim 1, wherein changing the frame rate of the input frame source comprises:
temporarily increasing the frame rate of the input frame source to obtain at least one additional input frame from the input frame source, wherein the multiple input frames comprise an initial input frame and the at least one additional input frame.

7. The method of claim 6, wherein changing the frame rate of the input frame source further comprises:
after temporarily increasing the frame rate of the input frame source, decreasing the frame rate of the input frame source, to make the frame rate be equal to an original frame rate, the original frame rate prior to starting changing the frame rate of the input frame source.

8. The method of claim 1, wherein changing the frame rate of the input frame source comprises:
temporarily increasing the frame rate of the input frame source, for accelerating a speed of applying the visual effect.

9. The method of claim 1, wherein the at least one predetermined activation criterion is related to at least one of the following: whether the image processing of the visual effect needs to be started, and whether previous image processing of the visual effect needs to be restarted.

10. The method of claim 1, wherein the at least one predetermined activation criterion comprises one of or a combination of:
a camera application is opened for a first time during a usage period of the electronic device, wherein the input frame source represents a camera;
a change in a number of detected faces is observed, wherein the visual effect comprises at least one facial effect; and
a facial detection algorithm of the image processing reaches at least one detection limit, the at least one detection limit including at least one of the following: a face angle reaches a predetermined face angle threshold, and a movement speed reaches a predetermined movement speed threshold.

11. The method of claim 1, wherein changing the frame rate of the input frame source comprises:
dynamically increasing the frame rate of the input frame source based on at least one need of at least one usage scenario.

12. The method of claim 1, wherein with aid of at least one additional input frame inserted within the predetermined time limit among the multiple input frames, the processing circuit is configured to enhance a complete effect rate of a series of output frames, the complete effect rate being a rate of a number of output frames having the visual effect to a number of the series of output frames.

13. The method of claim 1, wherein the at least one output frame is used as a part of a series of output frames for being displayed by the display under the control of the processing circuit; and the series of output frames are output frames belonging to a live stream.

14. The method of claim 1, wherein the visual effect comprises at least one facial effect.

15. The method of claim 1, wherein with aid of at least one additional input frame inserted within the predetermined time limit among the multiple input frames, the processing circuit is configured to reduce an effect disappearance rate of a series of output frames, the effect disappearance rate being a rate of a number of output frames without the visual effect to a number of the series of output frames.

16. The method of claim 1, wherein the frame rate represents a frame rate expressed with frame per second (FPS), and the at least one predetermined activation criterion represents at least one dynamic FPS activation criterion, for determining whether to change the FPS for enhancing the scene experience.

17. A chipset that is operating according to the method of claim 1, wherein the chipset is implemented by way of at least one integrated circuit (IC), and the processing circuit is positioned within the at least one IC.

18. The chipset of claim 17, wherein the at least one IC comprises a single IC corresponding to a system-on-chip (SoC) design.

19. The chipset of claim 17, wherein the at least one IC comprises multiple ICs within which the processing circuit and a communication control circuit are positioned, respectively, wherein the communication control circuit is arranged to perform communication control for the electronic device.

20. An electronic device, for performing adaptive frame rate adjustment in the electronic device for enhancing scene experience, the electronic device comprising:
a processing circuit, arranged to control operations of the electronic device; and
a display, coupled to the processing circuit, arranged to display information for the electronic device;
wherein:
the electronic device is arranged to utilize the processing circuit to determine whether at least one predetermined activation criterion regarding the adaptive frame rate adjustment is satisfied to generate at least one determination result, for selectively changing a frame rate of an input frame source within the electronic device according to the at least one determination result, wherein the at least one determination result indicates whether the at least one predetermined activation criterion is satisfied;
in response to the at least one determination result indicating that the at least one predetermined activation criterion is satisfied, the electronic device is arranged to utilize the processing circuit to change the frame rate of the input frame source, for obtaining multiple input frames from the input frame source within a predetermined time limit; and
the electronic device is arranged to utilize the processing circuit to perform image processing of a visual effect according to the multiple input frames to generate at least one output frame having the visual effect, for being displayed by the display under control of the processing circuit.
